(19) United States
(12) Patent Application Publication
(10) Pub. No.: US 2002/0069223 A1
(43) Pub. Date: Jun. 6, 2002

(54) Methods and systems to link data

(76) Inventors: Aaron A. Goodisman, Watertown, MA (US); Sandra E. Serkes, Watertown, MA (US)

Correspondence Address: FOLEY, HOAG & ELIOT, LLP, PATENT GROUP, ONE POST OFFICE SQUARE, BOSTON, MA, 02109, US

(21) Appl. No.: 09/970,202

(22) Filed: Oct. 3, 2001

Related U.S. Application Data
(60) Provisional application No. 60/249,498, filed on Nov. 17, 2000.

(51) Int. Cl. G06F 15/00

(52) U.S. Cl. 707/513

(57) ABSTRACT

A method and system to create dynamic associations or links between objects. The associations or links can be created by a linkify engine that creates the links by processing a document. The linkify engine can maintain and/or access at least one database or other memory component capable of storing data from which the associations can be formed. The linkify engine can also utilize configuration data to assist in determining associations. Objects in the document that can be linked by the linkify engine can include a word, group of words, number or group of numbers, image, icon, picture, or other object in a document. The document objects can be associated or linked to document objects in other documents, or to applications, images, icons, pictures, or other textual and non-textual objects that may not be associated with a document. In one embodiment, the association between objects can be represented as a hypertext link. Upon link activation, data from the associated objects can be retrieved and/or a process can be activated.

### CLAIM OF PRIORITY

This application claims priority to U.S. Ser. No. 60/249,498, entitled “Methods And Systems Integrating Wireless Web/Internet And Java-Based Application Servers”, and filed on Nov. 17, 2000, naming Sandra E. Serkes and Aaron A. Goodisman as inventors, the contents of which are herein incorporated by reference in their entirety.

### BACKGROUND

(1) Field

The disclosed methods and systems relate generally to increasing availability of information on a network, and more particularly to generating links to enhance network connectivity between data and related information and services.

(2) Description of Relevant Art

An increased amount of information is available to those who can access the internet. The available information can include personal information such as bank accounts, addresses, phone numbers, and email addresses, and consumer information that includes web sites having products for sale or auction. The term P2P or peer-to-peer describes the sharing of information between individuals, while the term B2B or business-to-business, describes transactions between businesses. Furthermore, general information is available, including research articles, term papers, course work, and presentations. In some instances, these resources can be obtained within an intranet that can serve an individual business, organization, company, etc.

As the popularity of the internet grows, there is an increased popularity in electronic devices. This increased popularity can be driving a trend towards miniaturization of electronic devices to allow portability and accessibility at remote locations. Accordingly, many otherwise traditional and modular electronic devices, including cellular phones, are becoming web-enabled using the wireless web and associated wireless protocols, to allow access to internet information and services from virtually any location.

In part because some of the miniature devices have traditionally smaller displays, in part because there are increased numbers of users seeking increased functionality from their electronic devices, and in part because there are an increased number of information providers, there is a need to integrate information and resources available on a network such as the internet.

### SUMMARY

The disclosed methods and systems provide associations or links from an object in a document to at least one other object based on context data. Context data can include data regarding a user's device, environment (e.g., time of day, location), actions, user profile, security clearance, job function and/or description, the document type, the document location, an application executing on the device, and the user's identity, although such examples are provided for illustration and not limitation, and context information, context data, and context filtering can be understood herein to include information or data, or the processing thereof, of data particular to the device, the device user, and/or the object to be linked. Link activation can cause a retrieval of data associated with at least one of the linked objects, and additionally and optionally, commencement of a process. Objects can include a document or portion thereof, including words, sentences, groups of words, numbers, or any other part of the document. Objects can also include database records, icons, figures, images, trademarks, pictures, and other non-textual content. Links between objects can include links that utilize hypertext protocols, but other protocols (e.g., secure Hypertext Transfer protocol (HTTPs), wireless telephony application interface (WTAI), file transfer protocol (FTP), file protocol (e.g., local files), news protocol (e.g., news groups or articles), gopher, mailto, telnet) can be used without departing from the scope of the disclosed methods and systems.

Link activation can be caused by a variety of techniques that include specifying, designating, or otherwise selecting a link. Link activation can cause a retrieval and/or presentation of information or data, where the data or information is associated with the linked objects. Additionally and optionally, link activation can activate a process such as an applet, a program, a script, computer instructions, or another process including a telephone call.

Linked objects can reside within resources such as databases, documents, and other storage media that can be internally or externally located to an organization, business, or other entity. In some embodiments, the linked objects can be accessed through a network including an intranet. Additionally and optionally, objects can be linked to objects that can be accessed via a network such as the internet.

A linkify engine that can include instructions that can be executed by a processor, can dynamically generate or otherwise provide the links between the objects. The linkify engine can retrieve data or other information from data sources or network accessible devices through the internet, intranet, or combination thereof, at fixed or otherwise determined intervals. The information or data can also be updated at given intervals, where the control of such updating can be performed by the linkify engine or, for example, a microprocessor or process associated with the network accessible devices or data sources from which the data is obtained or retrieved.

The linkify engine can generate links by parsing a document into blocks based in part on the document type, utilize context information to determine potential links from the blocks, utilize a pattern matcher to establish relationships between the blocks, and provide one or more outputs that can include the document and associated links. In some embodiments, the document and links can be in one linkified document, while in other embodiments, the document can be associated with another program and/or another document(s) that can, in combination, provide the links.

The linkify engine can include memory components and/or devices, including databases, to maintain data from internal and/or external data sources from which associations can be derived. The linkify engine can also use one or more configuration files to further define or specify link parameters.

Other objects and advantages will become apparent hereinafter in view of the specification and drawings.

### BRIEF DESCRIPTION OF THE DRAWINGS

FIG. 1 is a block diagram of one linkify engine having one input and output;

FIG. 2 is a block diagram showing links generated by the linkify engine;

FIG. 3 is an architectural block diagram providing sample communicative links for a linkify engine;

FIG. 4 presents a block diagram of sample features of a linkify engine;

FIG. 5 presents a more detailed block diagram of sample features for a linkify engine; and,

FIG. 6 illustrates a sample linkify output for an email document.

### DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore features, components, modules, and or aspects of the illustrations can be otherwise combined, separated, interchanged, and/or rearranged without departing from the disclosed systems or methods.

The methods and systems disclosed herein can be described relative to a network such as the internet, although the methods and systems can be applied to any network, wired or wireless, that can use a variety of communications protocols. Accordingly, it can be understood that references herein to the internet include references to any network.

The disclosed methods and systems can dynamically associate, for example, link objects in a document, to objects that can be accessed on or by network accessible devices, including other objects in the document. Objects can be a document or portion thereof, including words, sentences, groups of words, numbers, or any other part of the document. Objects can also include database records, icons, figures, images, trademarks, pictures, and other non-textual content included in a document. The document can be of varying formats, including ascii, pdf, binary, text, combinations thereof, or other types, with the document types provided explicitly as merely exemplary.

The links can be formed based on context data. Context data can include data regarding a user's device, environment (e.g., time of day, location), actions, user profile, security clearance, job function and/or description, the document type, the document location, an application executing on the device, and the user's identity, although such examples are provided for illustration and not limitation, and context information, context data, and context filtering can be understood herein to include information or data, or the processing thereof, of data particular to the device, the device user, and/or the object to be linked. Accordingly, those with ordinary skill in the art will recognize that, based on context filtering, the same information or data, or links thereto, can be presented to two different users in two different manners, or additionally and optionally, only presented to one of such users.

Links between objects can include links that utilize hypertext protocols, but other protocols (e.g, secure Hypertext Transfer protocol (HTTPs), wireless telephony application interface (WTAI), file transfer protocol (FTP), file protocol (e.g., local files), news protocol (e.g., news groups or articles), gopher, mailto, telnet) can be used without departing from the scope of the disclosed methods and systems. Additionally, the network upon which the objects can be linked can include one or more microprocessor-based systems that can be in communications with one or more storage and/or peripheral devices.

The methods and systems can also be applied to associating or linking data from an image (e.g. logo, picture, photograph, etc.), text-oriented audio content derived from Interactive Voice Response (IVR) systems, voice mail, telephone conversation or other audio data, audio-only access to the internet, and email readers. Accordingly, for the purposes of the discussion herein, references to documents or networked documents can include documents as previously provided herein, and also images and text-oriented audio content.

The networked documents can be viewed on or otherwise accessed by a device that can be referenced herein as an initiating device. In some embodiments, the associations that can link the documents to the devices can be hypertext links, for example. The links can be incorporated into and/or integrated with the networked documents for viewing, display, or other presentation (e.g., audible) on the initiating device. In an example where the links are hypertext links incorporated into a HTML document, the hypertext links can be associated with or otherwise provide direction to database information, web pages, other networked documents, and/or a device that can be accessed through the network. Examples of accessible devices can include cellular telephones, landline telephones, printers, servers, storage mechanisms, and computer peripheral devices, although such example devices are provided merely for illustration and not limitation. Activating a link can provide a communicative connection between the initiating device and the network accessible device, and the link activation may additionally and optionally cause information or other data to be communicated to what can herein be referred to as a target. For example, if the link is a hyperlink in a web page, and connects to another web page on a different server, the target can be a browser on the initiating device (e.g., activating the link can cause the linked page to be transferred to a browser page for display on the initiating device). In another example, activation of a link, where the initiating device can be a cellular phone, can cause a telephone connection between the initiating device and, for example, another telephone. In some embodiments, the target can be a document that includes a linked object; for example, link activation can cause text in one document to be replaced, be augmented with adjacent text, or be appended with information (e.g., abstract) or other data in a footnote or other presentation. In some embodiments, linked objects can reside on the same device, and additionally and optionally, a link can be between two objects in the same document.

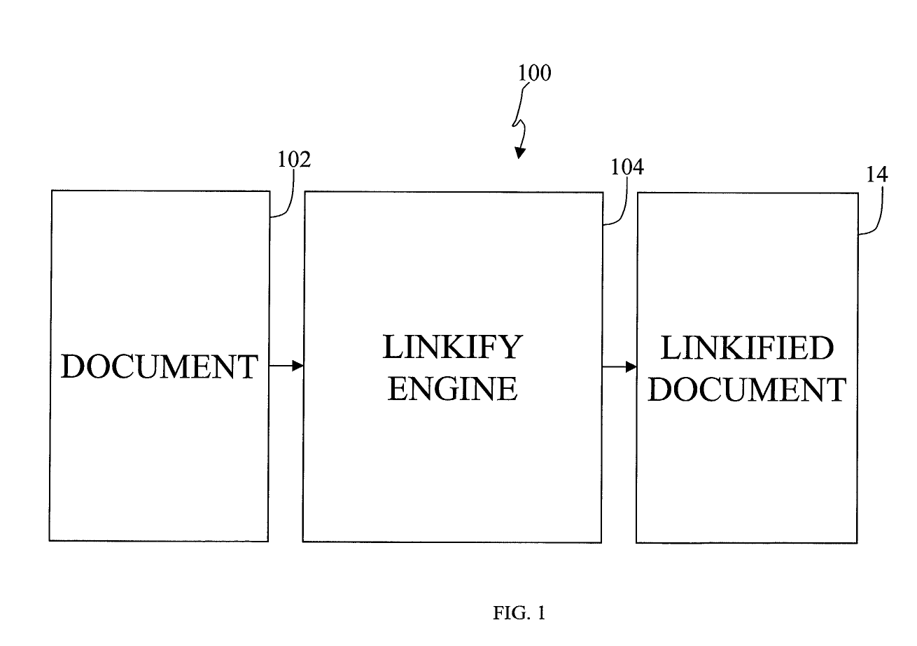

Referring to FIG. 1, there is a block diagram of a general process and system for providing links 100. A document 102 can be presented to a linkify engine 104 that includes processor-executable instructions. The linkify engine 104 can identify items within the document and generate links, to generate a linkified document 14. As will be disclosed herein, the generated links can be integrated in the linkified document 14 such that the linkified document maintains a general format to the document 102, while in other embodiments, the links can be included in a separate database or document that can be associated with the document 102.

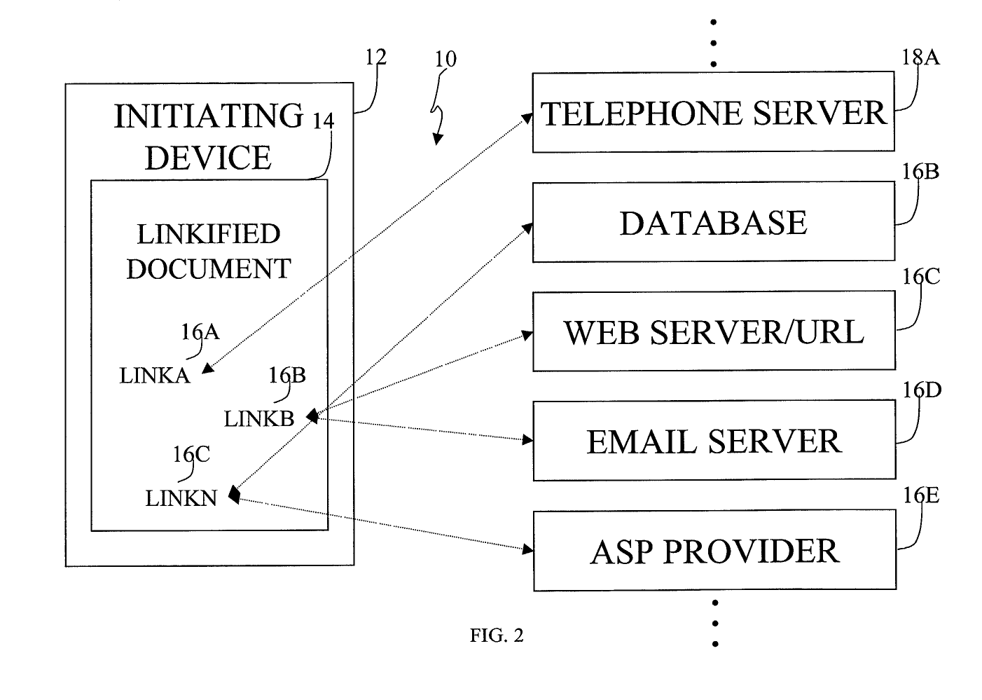

Referring now to FIG. 2, there is a illustrative system 10 that includes an initiating device 12 with a display for by presenting the linkified document 14. The illustrated linkified document 14, as a result of the methods and systems disclosed herein and provided in the linkify engine 104, includes several links 16a-16c to objects that can be located on network accessible devices 18a-18e, of which only five such devices are illustrated. The methods and systems are not limited to the number or type of network accessible devices 18a-18e. Accordingly, the FIG. 2 illustrated links 16a-16c can, when activated, provide one or more associations, connections, and/or links between the initiating device 12 and one or more of the objects on the illustrated network accessible devices 18a-18e. As will be provided herein, link activation can additionally and optionally initiate one or more activities, processes, or applications between the one or more linked or associated devices. For example, activation of a link related to a telephone number can cause a user's designated telephone to connect to a telephone associated with the link via a script or other application that is associated with the link. Similarly, link activation can cause a server to send a document or other file to a printer, storage device, email or other network server, etc. In some embodiments, the secondary devices (e.g., printer in the previous example) may not be otherwise accessible to the user of the initiating device.

For the purposes of the disclosed systems and methods, an initiating device 12 can include a digital computer system that can utilize a wired or wireless communications link to connect to a communication network such as the internet. A user of the initiating device 12 can utilize different peripheral devices that can be integrated with or otherwise configured for compatibility with the initiating device 12. For example, the initiating device 12 can include a keyboard, keypad, stylus, digital camera, microphone, etc., that can communicate data to the initiating device using wired or wireless communications systems and/or protocols, etc. The initiating device 12 can be a microprocessor-based system including a computer workstation, such as a PC workstation or a SUN workstation, handheld, palmtop, laptop, personal digital assistant (PDA), cellular phone, etc., that includes a program for organizing and controlling the initiating device 12 to operate as described herein. Additionally and optionally, the initiating device 12 can be equipped with a sound and video card for processing multimedia data. The initiating device 12 can operate as a stand-alone system or as part of a networked computer system. Alternatively, S the initiating device 12 can be a dedicated device, such as an embedded system, that can be incorporated into existing hardware devices, such as telephone systems, PBX systems, sound cards, etc. Accordingly, it will be understood by one of ordinary skill in the art that the initiating device 12 described herein has wide applicability and can be incorporated in many systems, and realized in many forms.

For a system according to FIG. 2, the initiating device 12 can be connected to a network such as the internet and can be equipped with what is well-known as an internet “browser” such as the commercially available Netscape Navigator, Internet Explorer, etc., browsers, and those with ordinary skill in the art will recognize that, depending upon the initiating device 12 and its configuration, the browser can differ, and hence references herein to a browser can include references to a user interface to the internet or other network, wherein the methods and systems herein are not limited to the browser or other network interface. Furthermore, the initiating device 12 can access the internet using wired or wireless communications links and/or protocols.

The illustrated linkified document 14, and additionally, the document 102 of FIG. 1 from which the linkified document 14 is formed, can include one or more document formats, for example, HTML (Hypertext Markup language), WML (Wireless Markup Language), HDML (Handheld Device Markup Language), XML (Extensible Markup Language), PDF (Portable Document Format), Microsoft Word, VoiceXML (Voice Mark-up Language), and RFC822 (Request for Comments #822, standard internet email format) documents, although such examples are provided for illustration and not limitation.

For the illustrated methods and systems, and as previously described herein, a link 16a-16c can be understood as a connection or association between a document or portion thereof, including a word(s), icon, image, picture, portion thereof, or another object, to another document or portion thereof, including a word(s), icon, image, picture, portion thereof, document record, application, or another object as previously defined herein. The links can use a protocol such as HTTP, secure Hypertext Transfer protocol (HTTPs), wireless telephony application interface (WTAI), file transfer protocol (FTP), file protocol (e.g., local files), news protocol (e.g., news groups or articles), gopher, mailto, telnet, etc., and such examples are provided for illustration and not limitation.

In some embodiments, the links can be selectable by a user, while in other embodiments, the links can be activated automatically upon link generation.

The objects connected by the links 16a-16c can be on separate servers or devices, or the same server or device. The objects can be designed to include sound and/or video. A link 16a-16c can include, for example, a hyperlink that can be a highlighted or underlined word or picture that can be activated and/or selected by a user with a mouse, keyboard, stylus, voice (microphone) or other peripheral device. As indicated herein, the links 16a-16c can be incorporated into the document 102 while maintaining the format of the document 102. In some embodiments, the linkified document 14 and the document 102 can be identical formats, while in some embodiments, the formats of the two documents can differ.

In some embodiments, links can be presented in a “link summary” format that can include a separate section presenting links for the document. The link summary can be appended to the end of a linkified document or page 14, provided as a footnote, associated with the linkified document via a hypertext or other link, etc. In an embodiment, the links can be formed for compatibility with a browser plug-in or other application, and in such embodiments, the linkified document 14 may not include visible indications of the links absent the accompanying plug-in or application. Such links can thus be referred to as encoded links. For example, in one embodiment, the linkify engine 104 can represent or otherwise provide links for compatibility with a text editor to allow the links to appear as a visual overlay to the document 102, such that the “linkified” document 104 may not be modified from the document 102. Accordingly, references to the linkified document 102 can be understood to include one or more objects (e.g., document and associated applet compatible with a plug-in) as provided herein, where the one or more objects can be associated to provide links as also provided herein.

The FIG. 2 links 16a-16c can be activated by selecting the link with a mouse, stylus, keypad, keyboard entry, voice activation, or other form of selection, where the methods and systems herein are not limited by the mode of link selection or activation. Link activation can cause data to be retrieved from either or both of the linked objects or other data associated with the linked objects, and the retrieved data can be provided to a target.

Targets can be understood to be a destination for data that can be retrieved or otherwise provided via a link selection or activation. Targets can be, for example, an object (e.g., document or portion thereof) as defined herein, or targets can include devices, applications, scripts, etc. In one example where a target is an object, a portion of a document can include a link, and when the link is activated, the object (e.g., text) can be replaced with other text, appended to, and/or a footnote created in the document. In an embodiment, a target can be a pop-up window that provides data or information regarding one or more of the linked objects (e.g., personal contact information, status of a telephone connection caused by the link activation, etc.). Targets can also include a telephone connection, a new browser window, a presentation of text that can be incorporated as an aside within a document, another document or window, or the present document or window (e.g., replace contents of present web page with linked web page, etc.). Those with ordinary skill in the art will recognize that there are various forms of targets, and the methods and systems herein are not limited to the type or format of targets.

In some applications and embodiments, multiple targets can be used, and multiple targets can be associated with a single link. The multiple targets can be related or unrelated. In one example of multiple targets, for a document 104 with a telephone number that can be identified and transformed to a link in the linkified document 14, such link activation can cause targets including a telephone connection and a pop-up window providing status on the telephone connection. Additionally and optionally, a pop-up window could be presented with the address or other information about the person or entity being called.

In some embodiments, a user can be provided with a list of possible targets, and the user can select one or more of the possible targets. The target list can be provided with a graphical user interface, for example, that can be presented on the initiating device 12. The target selections can be presented using radio buttons, check-boxes, drop-down selections, voice-activated presentations and selections, or other selectable options compatible with the methods and systems provided herein, with such examples provided for illustration and not limitation.

In summary, objects can be associated via links. Link activation can cause information or other data to be retrieved from either or both of the objects, optionally processed, and optionally presented or otherwise provided to one or more targets.

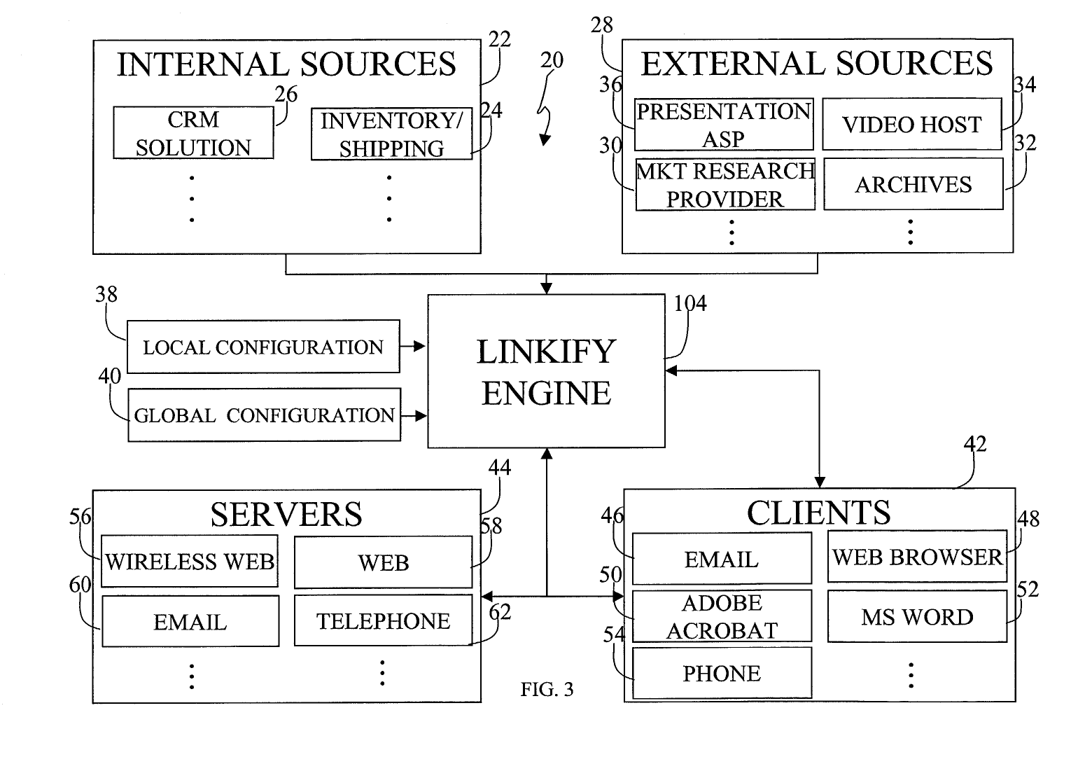

Referring now to FIG. 3, there is an example architectural block diagram 20 illustrating the different communicative aspects of a linkify engine 104. The linkify engine 104 can be a software module or set of software modules that can be implemented in one or more higher level languages and/or assembly code. For the illustrated systems, the linkify engine 104 can be a software module or set of software modules that can utilize a Java or J2EE platform to provide platform independence.

For illustrative purposes, the FIG. 3 system 20 can be discussed with respect to a supplier of goods and services. The linkify engine 104 can receive data from supplier-internal sources 22 that can include databases related to inventory, shipping information 24, other customer data, other supplier data, Customer Relationship Management (CRM) data 26, business goals data, etc. Data from external sources 28 can also contribute to the linkify engine and can include data from a market research provider 30, archive data from an external source 32, and data from a video host server 34 or a presentation ASP 36. Those with ordinary skill in the art will recognize that the example system of FIG. 3 is provided for illustration and not limitation, and the methods and systems disclosed herein are not limited to the internal 22 and/or external 28 sources. In some embodiments, for example, internal sources 22 may not be used. Furthermore, internal sources 22 and external sources 28 can be defined by implementation, and internal sources 22 can be understood herein to be sources that can be available on an intranet associated with a given linkify engine 104, while external sources 28 can be understood herein to include sources that are not available on the intranet associated with the given linkify engine 104.

Data from the internal 22 and external 28 sources can be provided to the linkify engine 104 using one or more of a variety of techniques that can be known to one of ordinary skill in the art. For example, the internal 22 and/or external 28 data sources can be accessed by the linkify engine 104 using standard protocols or Application Program Interfaces (APIs) such as Structured Query Language (SQL), Lightweight Directory Access Protocol (LDAP), Hypertext Transfer Protocol (HTTP), extensible Markup Language (XML), screen scraping, custom protocols, etc. The data from the internal 22 and external 28 sources can be filtered, parsed, and otherwise processed depending upon system requirements. In the illustrated embodiments, the data from the internal 22 and external 28 sources can be accessed or otherwise made available to the linkify engine 104, to be globally shared by the linkified documents 14. In some embodiments, for example, internal 22 and external 28 sources can provide abstract data, table of content information, index information, URLs indicating locations of other documents and/or objects, or other preliminary data that can be collectively referred to herein as catalog data, to the linkify engine 104. Additionally and optionally, the internal 22 and external 28 sources can provide more detailed, or complete data, to the linkify engine 104. Furthermore, the linkify engine 104 can be notified when an internal 22 or external 28 source changes. Additionally and optionally, the linkify engine 104 can poll the internal 22 and/or external 28 sources at fixed or variable intervals that can be different for different sources 22, 28, to determine whether a source 22, 28 may have changed, and whether the linkify engine 104 information from such source 22, 28 should be updated.

Accordingly, the methods and systems can be configured to remove and/or replace links that can be present in a linkified document, based on updated information and other techniques that can include applications based on link integrity management. Links can be removed entirely, updated with a new destination, and/or replaced with a different link. In an embodiment, the link removal and replacement feature can continually process linkified documents 14 with the latest link information to update links and direct or redirect a link to provide the most recent or appropriate information. In some embodiments, links can require updating, removal, and/or replacement based on changes to the global and/or local configurations or other information that can be updated and provided to the linkify engine 104.

The illustrated linkify engine 104 can utilize information from a local configuration 38 and/or a global configuration 40 to determine how to query or otherwise interface with the internal 22 and external 28 sources. The configuration files 38, 40 can therefore provide data to perform the link identification and establishment. Accordingly, the FIG. 3 local configuration 38 can be established by a system administrator or other personnel familiar with the supplier's business strategy, objectives, and/or structure. The local configuration 38 in such an embodiment can include data based on job categories within the supplier organization. Based on job category, the supplier system administrator can identify and specify for the linkify engine 38, those parts of the data from internal and/or external data sources 22, 28 that can or should be identified and linkified based on a job category or other employee description. Accordingly, the linkify engine 104 can provide employees access to the internal and/or external data to optimize the information that can be most helpful to them, without having the linkify engine 104 provide links to information, objects, or other data that is not helpful. Additionally and optionally, the local configuration data 38 can attach security to different job categories by opting not to generate links based on job category.

The global configuration 40 can be similar to the local configuration 38 and can be utilized in similar manners; however, in the FIG. 3 system 20, the global configuration 40 can specify generic configuration data that can useful to broader categories of user of the linkify engine 104 (compare to the local configuration 38 that can be particularized to a given user). In an embodiment, the local configuration 38 can have priority over the global configuration 40. In some embodiments, the global configuration 40 can be provided by a centrally located server that can be in communication with the linkify engine 104, and updates to the linkify engine 104 can be provided remotely. In an embodiment, the global configuration can be pre-installed on the linkify engine 104, and additionally and optionally, the global 40 and local 38 configurations can be integrated or otherwise combined in a single configuration.

As provided herein, the linkify engine 104 can also include and/or maintain communications with one or more databases or other memory devices or components to maintain information or other data from the internal data sources 22, the external data sources 28, the local configuration 38, and/or the global configuration 40. In some embodiments, the linkify engine 104 can utilize cache memory. The memory can be accessed by the linkify engine 104 to determine links, and such memory can thus include objects and other data related to or associated with objects (e.g., applications, targets, URLs of objects, and other configuration data as provided herein) to which links in the document 102 can be generated. Such memory can therefore be referred to herein as object memory, and objects from the document 102 can be linked to or otherwise associated with data and/or objects in object memory. In some embodiments, object memory can include pointers or other references to the internal and external sources 22, 28. Accordingly, when a user activates a link in the linkified document 14, data can be retrieved from object memory that can then direct data transmission and/or retrieval to and/or from another device or location.

The FIG. 3 linkify engine 104 can process requests from clients 42 and servers 44. Illustrated clients can include, for example, an email client 46, a web browser 48, a program that displays a document that can be in a particular format including Word 50 or Adobe Acrobat 52, and a telephone or other networked device 54. Furthermore, servers 44 can include a wireless web server 56, a web server 58, an email server 60, and a telephone server 62. Those with ordinary skill in the art will recognize that the methods and systems are not limited to the illustrated clients and servers, and the FIG. 3 embodiment is provided merely for illustration.

In the FIG. 3 system, requests from the clients 42 can be received by the servers 44. The client-server model is well known as a relationship between a requester program, otherwise known as the client 42, and the program that services the request, otherwise known as a server 44. It is also well-known that the client 42 and server 44 can reside on the same device or different devices, and such understanding can be applied to the disclosed methods and systems and to FIG. 3. Accordingly, the features of the linkify engine 104 can be applied to requests using a variety of communications routes between the clients 42 and the servers 44. For example, the linkify engine 104 can intercept a request from a client 42, process the request based on the linkify methods and systems disclosed herein, and forward the linkified request to a server 44 for processing. The processed request can be returned to the client 42 via the linkify engine 104, or through another communication path that may not include the linkify engine 104. Additionally and optionally, a request from a client 42 can be submitted to a server 44, and the server 44 can thereafter transfer the processed or unprocessed request to the linkify engine 104. Depending upon whether the server 44 provided the linkify engine 104 with a processed or unprocessed request, the linkify engine 104 can return the linkified request to the server 44 or client 42. Such illustrations of the linkify engine 104 processing are provided merely as examples, and not for limitation. Those with ordinary skill in the art will therefore recognize that the linkify engine 104 can be customized to include content and satisfy a given system architecture as provided by various applications or uses of the linkify engine 104. In some embodiments,, the linkify engine 104 can be provided in a “forwarding linking” configuration where information can be “pushed” to a user by intercepting an email, linkifying the email before the recipient receives the email, and providing to the user a linkified email. In some embodiments, “reverse” or “back” linking can be performed by presenting a document to the linkify engine 104 to allow the linkify engine to return a linkified document 14 by forming links from databases, object memory, etc. The linkified document 14 could then be provided to others.

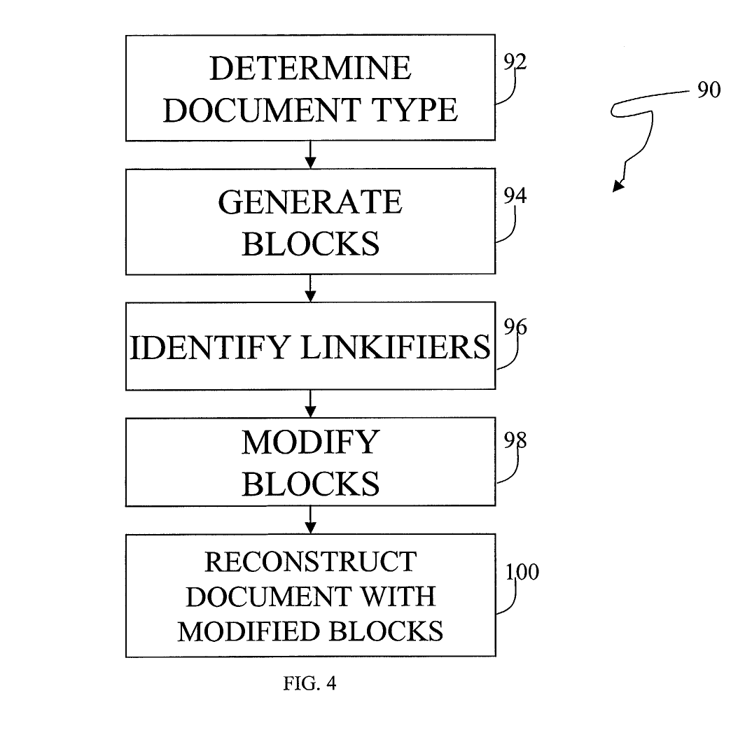

Referring now to FIG. 4, there is an architectural block diagram 90 of some features of a linkify engine 104. The illustrated linkify engine 104 can identify a document type or format 92, divide the document into blocks 94 based on the document type (e.g., text blocks for a text document, image blocks for a document including images, etc.), and identify modules 96 from the blocks that can or should be represented as a link, based on the contents of object memory. The modules can be an object as provided herein, and in some embodiments, the blocks 94 can be an object. Accordingly, a block 94 can include one or more objects. In the FIG. 4 embodiment in which the linkified document 14 includes the links (compare to other embodiments in which the links can be a separate entity in the document, or 126 otherwise associated with the document), the illustrated linkify engine 104 can modify the blocks to provide a link 98, and reconstruct the document 100 using the modified blocks. The result can be a linkified document 14. Those with ordinary skill in the art will recognize that the FIG. 4 system presents only one embodiment for creating linkified documents 14, and some other embodiments (i.e., creating companion documents for companion applications to provide an overly of links, etc.) were previously discussed herein.

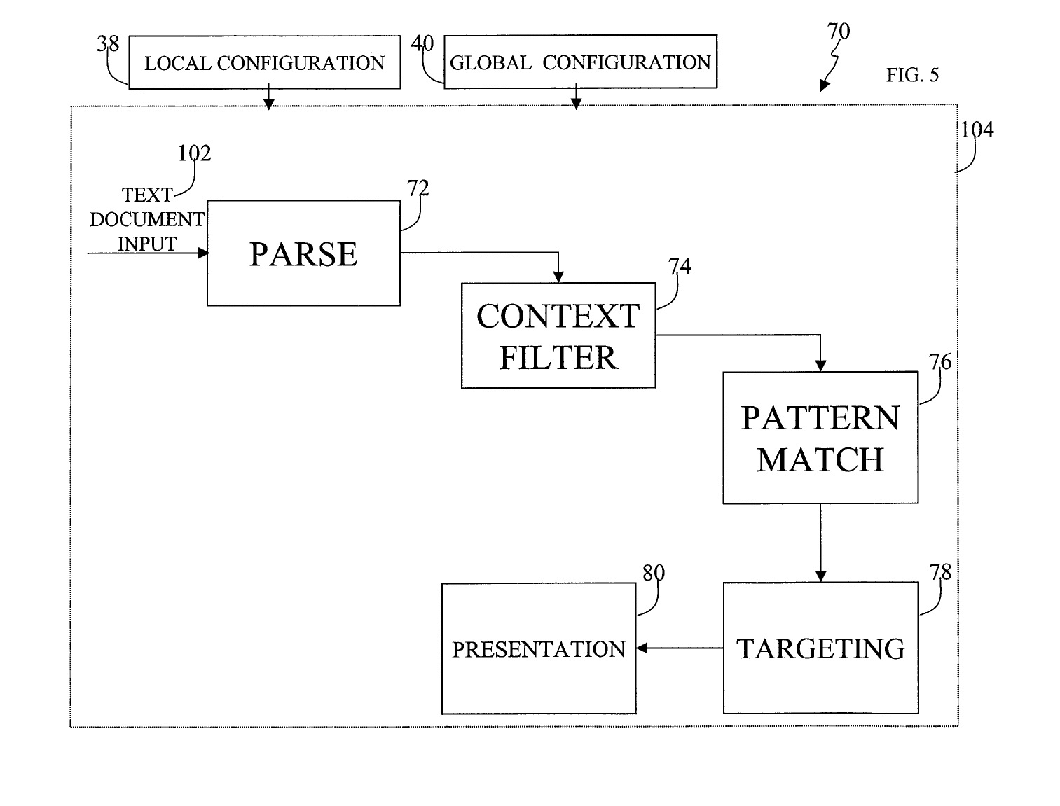

Referring now to FIG. 5, there is a block diagram 70 presenting more detailed features of one embodiment of a linkify engine 104. As FIG. 5 illustrates, the linkify engine 104 can receive a document 102 as input and can parse the document into blocks based on one or more parsing techniques 72. For example, the parser 72 can divide the document 102 based on document format elements including HTML or XML tags, or textual elements including sentences, questions, line breaks, spaces, hyphens, dashes, strings of digits, strings of letters, groups of words, or images, icons, etc. The parser 72 can be dependent upon the type of input document 102. The linkify engine 104 can also use a context filter 74 to determine which potential links are appropriate based on context information or data about the document 102, the user(s) who originated the document 102, the viewers of the document 102 (and hence the linkified document 14), applications or processes in which those users may be active, the requesting device, the requesting user's identity (communicated from the initiating device), the user(s) location (communicated from the initiating device), the user(s) time of day, job function or description, security clearance, configuration or profile data associated with the user, etc., with such examples provided for illustration and not limitation. The illustrated linkify engine 104 can also utilize a pattern matcher 76 to establish and/or refine relationships between the blocks and data in object memory, using data gathered from the context filter 74. In one embodiment, the pattern matcher 76 can include a natural language processor. Additionally and optionally, the pattern matcher 76 can process blocks, and also process the original document 102 to obtain additional context information. Other features of the pattern matcher 76 can include linguistic, keyword proximity, and word sequence analysis. Accordingly, the pattern matcher 76 can identify names, locations, telephone numbers, social security numbers, credit card numbers, addresses, streets, zip codes, etc., although such a list is provided for illustration and not limitation. The pattern matcher 76, and other linkify engine 104 features, can then be integrated with, for example, local/global configuration data 38, 40 to determine whether a name, for example, is relevant to a particular user and henceforth, the name, as an object, should be linked to other information related to the name. In one embodiment, information related to the name can include address (street and/or email) information, telephone (home, business, mobile, etc.) information, shipping information, credit card preferences, account information, customer information, etc. Accordingly, the linkify engine 104 can modify the text to translate the name to a link that, when activated, retrieves, displays, and/or otherwise processes the related information. As provided herein, the linkify engine 104 can recognize or otherwise identify many other forms of information and/or objects, and based on configuration data and other data accessible to the linkify engine 104 through object memory, generate associations between the objects in the document and object memory. Accordingly, the illustrated linkify engine 104 can also include a targeting feature 78 that can format the information for the target that will display and/or utilize the retrieved and/or processed information. An illustration of some targets is provided previously herein, and includes links, telephone dials/servers, pop-up windows, asides, etc. Depending upon how the retrieved information will be presented, the linkify engine 104 can reconstruct the document 102 to include the links and the appropriate presentation of the retrieved information, thereby generating the linkified document 14. In the FIG. 5 system, these features can be performed by the presentation module 80. Accordingly, the presentation module can create links with features that can include anchor links, icons, call-outs, footnotes, cursor hover presentation, abstract representation, etc. The output of the illustrated presentation module 80, and hence the illustrated linkify engine 104, can be a linkified document 14 that can include visible links between objects in a document 104, and other available information. In one embodiment, the links can be indicated using a highlighting feature, while in other embodiments, the links can be underlined, bolded, shadowed, outlined, or use a combination thereof. Those with ordinary skill in the art will recognize that the methods and systems disclosed herein are not limited to the method of displaying or identifying a link.

In an embodiment, linkified documents 14 can be associated with a selectable option to allow links to be visible or non-visible, or otherwise encoded. For example, a user-selectable option could include a toggle switch or button that can be incorporated into the linkified document 14, or alternately, into a plug-in or other compatible application that is associated with the linkified document 14. In some embodiments, the selectable option can be controlled by a system administrator that can control the options via a configuration file, for example, depending upon job category and/or another criteria. Links can be categorized or otherwise associated based on category or class, and accordingly, in some embodiments, links can be viewed according to category or class.

As indicated previously herein, the linkify engine 104 features presented in FIG. 5 are merely an illustration, and many variations can be performed. As provided herein, the features of the linkify engine can use the global and/or local configuration data 38, 40 to enhance feature effectiveness. Accordingly, in some embodiments, the linkify engine 104 features can be divided amongst several processors, and thereafter divided into global and/or local processing of such features. For example, in one embodiment, one processor can provide a linkify engine 104 based on local configuration data 38, while a second processor can independently or dependently provide a linkify engine 104 based on global configuration data 40. The data from the two linkify engines can be transferred to one or two presentation modules 100 to construct the linkified document 104.

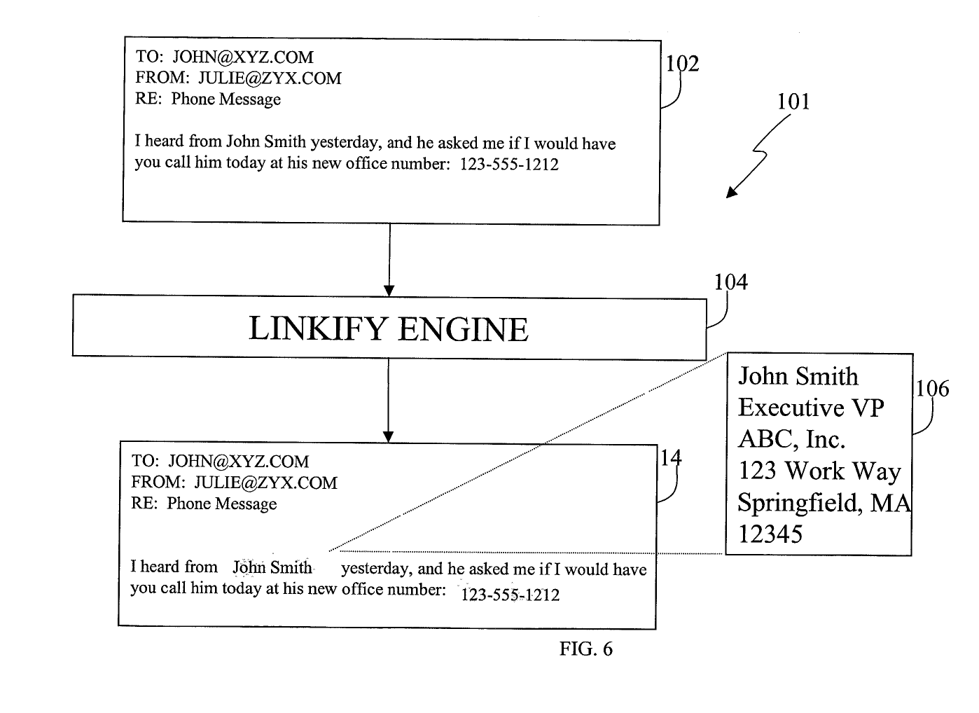

Referring now to FIG. 6, there is a sample illustration of the linkify engine 104 as disclosed herein. As FIG. 6 indicates, a document 102 in the form of an email can be presented to the linkify engine 104, wherein links can be identified and created based on the methods and systems disclosed herein, and the output of the linkify engine 104 can be a linkified document in the form of an email 14. As the FIG. 6 illustration indicates through highlighting, two links were created based on the linkify engine 104: The name “John Smith”, and the telephone number “123-555-1212.” If a user viewing the email activates (e.g., click, hover, etc.) the “John Smith” link, a pop-up window 106 can appear to display database information regarding John Smith. Additionally, if the telephone number link is activated, using configuration information, the link activation can provide a connection between the user's telephone line, and the linked telephone number. For example, in one embodiment, activating a telephone link can cause the user's line to ring. Upon detecting that the user's hand-set is picked-up, the link can cause the linked number to be dialed.

As indicated previously herein, in some embodiments, the links may not be selectable, and the linkify engine 104 can be configured to generate the links and automatically activate the links. For example, in one embodiment of automatic link activation, a document 102 presented to the linkify engine 104 can produce a linkified document 14 that includes replaced text, updated text, additional information, etc.

Those with ordinary skill in the art will therefore recognize that from the illustrated embodiments that the disclosed methods and systems can be used to linkify customer order forms to financial, shipping, inventory, contact, and rebate data, among other data. In another embodiment, an email can be linked to a management system, contact information, product and/or customer databases, etc. Such example embodiments are provided for illustration of the methods and systems. Accordingly, those with ordinary skill in the art will recognize that there are many applications for which the disclosed methods and systems can be utilized. Emails, web pages, word processing documents, etc., can be linked to database records, other emails, web pages, word processing documents, etc. Context sensitivity and configuration features can allow dynamic, pertinent links that can be generated at locally and/or at a central location.

What has thus been described are methods and systems to create dynamic associations or links between objects. The associations or links can be created by a linkify engine that creates the links by processing a document. The linkify engine can maintain and/or access at least one database or other memory component capable of storing data from which the associations can be formed. The linkify engine can also utilize configuration data to assist in determining associations. Objects in the document that can be linked by the linkify engine can include a word, group of words, number or group of numbers, image, icon, picture, or other object in a document. The document objects can be associated or linked to document objects in other documents, or to applications, images, icons, pictures, or other textual and non-textual objects that may not be associated with a document. In one embodiment, the association between objects can be represented as a hypertext link. Upon link activation, data from the associated objects can be retrieved and/or a process can be activated.

The methods and systems described herein are not limited to a particular hardware or software configuration, and may find applicability in many computing or processing environments. The methods and systems can be implemented in hardware or software, or a combination of hardware and software. The methods and systems can be implemented in one or more computer programs executing on one or more programmable computers that include a processor, a storage medium readable by the processor (including volatile and non-volatile memory and/or storage elements), one or more input devices, and one or more output devices.

The computer program(s) is preferably implemented using one or more high level procedural or object-oriented programming languages to communicate with a computer system; however, the program(s) can be implemented in assembly or machine language, if desired. The language can be compiled or interpreted.

The computer program(s) can be preferably stored on a storage medium or device (e.g., CD-ROM, hard disk, or magnetic disk) readable by a general or special purpose programmable computer for configuring and operating the computer when the storage medium or device is read by the computer to perform the procedures described herein. The system can also be considered to be implemented as a computer-readable storage medium, configured with a computer program, where the storage medium so configured causes a computer to operate in a specific and predefined manner.

Although the methods and systems have been described relative to a specific embodiment thereof, they are not so limited. Obviously many modifications and variations may become apparent in light of the above teachings.

Many additional changes in the details, materials, and arrangement of parts, herein described and illustrated, can be made by those skilled in the art. Accordingly, it will be understood that the following claims are not to be limited to the embodiments disclosed herein, can include practices otherwise than specifically described, and are to be interpreted as broadly as allowed under the law.

What is claimed is:

1. A method for associating a first object in a document on a device, to a distinct second object, the method comprising associating the first object and the second object based on context data.

2. A method according to claim 1, wherein associating includes associating based on data particular to at least one of the device, a user of the device, and the first object.

3. A method according to claim 1, wherein associating includes associating based on at least one of a time of day, a location, a user profile, a security clearance, a job function, a job description, the document type, the document location, an application executing on the device, and a user identity.

4. A method according to claim 1, wherein the first object is at least one of a word, sentence, group of words, number, icon, figure, image, trademark, or picture.

5. A method according to claim 1, wherein the first object is non-textual.

6. A method according to claim 1, wherein the second object is at least one of a document, word, sentence, group of words, database record, number, icon, figure, image, trademark, or picture.

7. A method according to claim 1, wherein the second object is non-textual.

8. A method according to claim 1, wherein associating includes dynamically associating.

9. A method according to claim 1, including providing at least one memory to store data based on the second object.

10. A method according to claim 1, wherein associating includes generating a selectable link.

11. A method according to claim 1, further including encoding the association.

12. A method according to claim 1, further including encoding the association based on at least one of a user profile, a document type, a document location, an application type, and the device type.

13. A method according to claim 1, wherein associating includes generating a hypertext link.

14. A method according to claim 1, further including providing at least one association feature including at least one of an anchor link, an icon, a call-out, a footnote, a cursor hover, a visibility, and an abstract representation.

15. A method according to claim 1, wherein associating includes associating based on at least one of natural language processing of the document, linguistic processing of the document, keyword proximity, and word sequence analysis of the document.

16. A method according to claim 1, wherein the document format includes at least one of HTML (Hypertext Markup language), WML (Wireless Markup Language), HDML (Handheld Device Markup Language), XML (Extensible Markup Language), PDF (Portable Document Format), Microsoft Word, VoiceXML (Voice Mark-up Language), and RFC822 (Request for Comments #822, standard internet email format).

17. A method according to claim 1, wherein associating includes identifying at least one target.

18. A method according to claim 1, further including presenting a selection of targets to a user of the device.

19. A method according to claim 1, wherein associating includes identifying at least one of a link, a telephone server, a pop-up window, an application, and an aside.

20. A method according to claim 1, wherein associating includes associating a plug-in with the association between the first object and the distinct second object.

21. A method according to claim 1, further including,
providing an object memory based on at least one of an external source, an internal source, a local configuration, and a global configuration, and,
selecting the distinct second object based on object memory data.

22. A method according to claim 1, wherein associating includes providing at least one application to be executed upon selection of the association.

23. A method according to claim 1, wherein associating includes executing at least one application.

24. A method according to claim 1, wherein associating includes providing at least one of a footnote, an index, and a link summary based on the association.

25. A method according to claim 1, wherein associating further includes providing a protocol that includes at least one of Hypertext transfer protocol (HTTP), secure Hypertext Transfer protocol (HTTPs), wireless telephony application interface (WTAI), file transfer protocol (FTP), file protocol, news protocol, gopher, mailto, and telnet.

26. A method according to claim 1, wherein associating includes altering the document based on the association between the first object and the distinct second object.

27. A method according to claim 1, further including updating the association.

28. A method for creating a link, the method comprising,
providing a document having at least one object,
providing at least one object memory based on at least one of a local configuration and a global configuration,
creating the link between the at least one first object and the object memory based on context data.

29. A method according to claim 28, wherein creating the link includes associating based on data particular to at least one of a device associated with the document, a user of the device, and the at least one object.

30. A method according to claim 28, wherein creating the link includes associating based on at least one of a time of day, a location, a user profile, a security clearance, a job function, a job description, the document type, the document location, an application executing on the device, and a user identity.

31. A method according to claim 28, wherein the at least one object is at least one of a word, sentence, group of words, number, icon, figure, image, trademark, or picture.

32. A method according to claim 28, further including encoding the link.

33. A method according to claim 28, further including updating the link.

34. A method according to claim 28, further including updating the link based on an update to the object memory.

35. A method according to claim 28, wherein creating the link includes creating the link based on at least one of linguistic processing of the document, natural language processing of the document, regular expression analysis of the document, keyword proximity,

36. A method according to claim 28, wherein providing at least one object memory includes retrieving information from at least one of external data sources and internal data sources.

37. A method according to claim 28, wherein providing at least one object memory includes updating the object memory based on updates to at least one of the global configuration, the local configuration, an external data source, and an internal data source.

38. A method according to claim 28, wherein providing a document includes providing a document over a network.

39. A method according to claim 28, wherein creating the link includes associating a visibility option with the link.

40. A method according to claim 28, wherein creating the link includes executing an application based on the link.

41. A system for associating at least one first object in a document on a device, to at least one distinct second object, the system comprising:
at least one object memory, the at least one object memory including the at least one distinct second object, and,
a processor with instructions for causing the processor to create the association based on context data.

42. A system according to claim 41, wherein the at least one object memory includes data from at least one of a local configuration, a global configuration, an internal data source, and an external data source.

43. A system according to claim 41, wherein the processor includes instructions for updating the at least one object memory.

44. A system according to claim 41, wherein the instructions for creating the association include instructions based on at least one of data particular to at least one of the device, a user of the device, and the at least one first object.

45. A system according to claim 41, wherein the instructions for creating the association include instructions based on at least one of a time of day, a location, a user profile, a security clearance, a job function, a job description, the document type, the document location, an application executing on the device, and a user identity.

46. A system according to claim 41, wherein the instructions for creating the association include instructions for encoding the association.

47. A system according to claim 41, wherein the at least one first object is at least one of a word, sentence, group of words, number, icon, figure, image, trademark, or picture

48. A system according to claim 41, wherein the at least one distinct second object is at least one of a document, word, sentence, group of words, database record, number, icon, figure, image, trademark, or picture

49. A computer product for associating a first object in a document on a device, to a distinct second object, the computer product comprising a processor and instructions for causing the processor to associate the first object and the second object based on context data.

50. A computer product according to claim 49, wherein the instructions to associate further include instructions to associate based on data particular to at least one of the device, a user of the device, and the first object.

51. A computer product according to claim 49, wherein the instructions to associate further include instructions to associate based on at least one of a time of day, a location, a user profile, a security clearance, a job function, a job description, the document type, the document location, an application executing on the device, and a user identity.

52. A computer product according to claim 49, wherein the first object is at least one of a word, sentence, group of words, number, icon, figure, image, trademark, or picture.

53. A computer product according to claim 49, wherein the second object is at least one of a document, word, sentence, group of words, database record, number, icon, figure, image, trademark, or picture.

54. A computer product according to claim 49, wherein the instructions to associate further include instructions to encode the association.

55. A computer product according to claim 49, wherein the instructions to associate further include instructions to encode the association based on at least one of a user profile, a document type, a document location, an application type, and the device type.

56. A computer product according to claim 49, wherein the instructions to associate further include instructions to associate based on at least one of natural language processing of the document, linguistic processing of the document, keyword proximity, and word sequence analysis of the document.

57. A computer product according to claim 49, wherein the instructions to associate further include instructions to present a selection o f targets to a user of the device.

58. A computer product according to claim 49, wherein the instructions to associate further include instructions to identify at least one of a link, a telephone server, a pop-up window, an application, and an aside.

59. A computer product according to claim 49, wherein the instructions to associate further include instructions to alter the document based on the association between the at least one first object and the at least one distinct second object.
